(19) United States
(12) Patent Application Publication
(10) Pub. No.: US 2023/0011407 A1
(43) Pub. Date: Jan. 12, 2023

(54) HEAD-UP DISPLAY APPARATUS

(71) Applicant: LG ELECTRONICS INC., Seoul (KR)

(72) Inventors: Yong Uk LEE, Seoul (KR); Ki Hoon LEE, Seoul (KR); Kyung Lack KIM, Seoul (KR)

(73) Assignee: LG ELECTRONICS INC., Seoul (KR)

(21) Appl. No.: 17/778,811

(22) PCT Filed: Nov. 21, 2019
(86) PCT No.: PCT/KR2019/016039

§ 371 Date: May 20, 2022

(51) Int. Cl. B60K 35/00; G02B 27/01; G02B 27/28; G02B 30/27; G02B 30/30

(52) U.S. Cl. CPC B60K 35/00; G02B 27/0101; G02B 27/286; G02B 27/288; G02B 30/27; G02B 30/30; B60K 2370/1529; B60K 2370/23; B60K 2370/25; B60K 2370/334; B60K 2370/785; G02B 2027/011; G02B 2027/0127; G02B 2027/014

(57) ABSTRACT

A head-up display apparatus is disclosed. The head-up display apparatus according to one embodiment of the present invention comprises: a display panel; a stereoscopic image filter; and a mirror. The display panel includes a first region in which a first image is displayed and a second region in which a second image is displayed, and the stereoscopic image filter is configured to convert the first image into a stereoscopic image. In an embodiment of the present invention, the first image displayed on the display panel is warped and displayed, thereby preventing distortion of the stereoscopic image when projected on a windshield.

### TECHNICAL FIELD

The present disclosure relates to a head-up display apparatus for a vehicle.

### BACKGROUND ART

A head-up display (HUD) is a device that projects a virtual image onto the area visible to the driver, which provides an advantage in that a driver does not have to look directly at an instrument panel or the like in order to check information necessary for driving.

The head-up display apparatus was initially developed for military use (aircraft use), but is now being used in commercial aircraft, automobiles, and other applications.

In relation to the head-up display apparatus, Korean Patent No. 0813492 discloses a head-up display apparatus for a vehicle capable of realizing three-dimensional image information. The device according to Korea Patent No. 0813492 is configured to include a light source for emitting illumination light, a micro display panel, a filter for conversion into a stereoscopic image, and a mirror system.

Korea Patent No. 0813492 discloses, as an example of a filter for realizing a stereoscopic image, a lenticular lens, and a slit array plate using a parallax method, thereby providing the advantage of configuring a slim device capable of implementing a three-dimensional stereoscopic image.

However, it is continuously required to develop a head-up display apparatus capable of more effectively displaying and delivering necessary information while driving a vehicle.

### DISCLOSURE OF INVENTION

### Technical Problem

A problem to be solved by the present disclosure is to provide a head-up display apparatus that may display safety-related information in 3D during driving of a vehicle to strengthen visibility, quickly provide information, and accurately display 3D images.

Another problem to be solved by the present disclosure is to provide a head-up display apparatus in which, when an image is three-dimensionally projected onto a windshield, the image may be corrected to conform to curved information of the windshield and then projected onto the windshield.

Another problem to be solved by the present disclosure is to provide a head-up display apparatus that may enable 3D expression in a glasses-free manner in a specific area and conversion between 3D and 2D modes.

Another problem to be solved by the present disclosure is to provide a head-up display apparatus capable of adjusting the degree of stereoscopicity (depth level) while enabling glasses-free 3D expression in a specific area.

### Solution to Problem

In order to solve the above problems, a head-up display apparatus according to the embodiment of the present disclosure may be configured as follows.

A head-up display apparatus according to the embodiment of the present disclosure may be configured to project an image onto a curved windshield.

A head-up display apparatus according to the embodiment of the present disclosure may be configured to include a display panel, a stereoscopic image filter, and one or more mirrors.

The display panel may be configured to include a first region in which a first image is displayed and a second region in which a second image is displayed.

The stereoscopic image filter is disposed in front of the first region to convert the first image into a stereoscopic image.

The mirror is configured to project an image of the second region and an image that has passed through the stereoscopic image filter onto the windshield.

According to the embodiment of the present disclosure, the first image may be warped and displayed on the display panel so that distortion of the image projected onto the windshield is reduced.

The mirror may include a concave mirror, and the concave mirror may be configured to include a first reflection region and a second reflection region.

The first reflection region is a region from which an image according to the first region is reflected.

The second reflection region is a region, separated from the first reflection region, from which an image according to the second region is reflected.

In the embodiment of the present disclosure, a radius of curvature of the first reflection region and a radius of curvature of the second reflection region may be different from each other.

In a head-up display apparatus according to the embodiment of the present disclosure, the stereoscopic image filter may be configured to include a parallax barrier.

The distance between the display panel and the stereoscopic image filter may be variable.

A disparity image in which a left eye image and a right eye image are combined may be displayed on the display panel.

The first image may be a disparity image in which a left eye image and a right eye image are combined, and the distance between the left eye image and the right eye image may be variable.

The left eye image and the right eye image may be respectively warped and displayed on the display panel to form the disparity image.

The stereoscopic image filter may be configured to include a polarization controller and a first liquid-crystal lenticular lens sheet.

The polarization controller is configured to change the polarization direction of a light beam constituting the first image.

The first liquid-crystal lenticular lens sheet is configured to refract or not refract a light beam that has passed through the polarization controller according to the polarization direction.

The stereoscopic image filter may be configured to include a first transparent electrode, a second liquid-crystal lenticular lens sheet disposed in front of the first transparent electrode, a lens body disposed in front of the second liquid-crystal lenticular lens sheet, and a second transparent electrode disposed in front of the lens body.

The refractive indices of the second liquid-crystal lenticular lens sheet and the lens body may be controlled to be the same as or different from each other depending on a voltage that is or is not applied to the second liquid-crystal lenticular lens sheet through the first transparent electrode and the second transparent electrode.

The first transparent electrode may include a 1-1st transparent electrode and a 1-2nd transparent electrode, which are separated from each other, and the second transparent electrode may include a 2-1st transparent electrode and a 2-2nd transparent electrode, which are separated from each other.

The operation of the 1-1st transparent electrode and the 2-1st transparent electrode configuring a pair may be performed separately from the operation of the 1-2nd transparent electrode and the 2-2nd transparent electrode configuring a pair.

In the embodiment of the present disclosure, the degree of warping of the first image may be controlled depending on the curvature of a projected point on the windshield.

In a head-up display apparatus according to the embodiment of the present disclosure, the stereoscopic image filter may be disposed in front of the display panel to convert an image of the display panel into a stereoscopic image.

In addition, the image may be configured to be warped and displayed on the display panel so that distortion of the image projected onto the windshield is reduced.

A head-up display apparatus according to the embodiment of the present disclosure may include a display panel configured to produce and display an image, a stereoscopic image filter disposed in front of the display panel to convert at least a partial image of the display panel into a stereoscopic image, and an optical system configured to cause light passing through the stereoscopic image filter to form an image, wherein the image may be warped and displayed on the display panel.

### Advantageous Effects of Invention

In the head-up display apparatus according to the embodiment of the present disclosure, the display panel includes a first region in which a first image is displayed and a second region in which a second image is displayed, and a stereoscopic image filter is disposed in front of the first region to convert the first image into a stereoscopic image. The first image is warped and displayed on the display panel to reduce distortion of the image projected onto a windshield. Accordingly, it is possible to display information related to safety in 3D through the first region during driving of a vehicle, thereby enabling enhancement of visibility, fast delivery of information, and accurate 3D expression.

In the head-up display apparatus according to the embodiment of the present disclosure, the first image may be a disparity image in which a left eye image and a right eye image are combined, and the left eye image and the right eye image may be respectively warped and displayed on the display panel to configure a disparity image. Accordingly, when an image is projected and displayed in 3D on the windshield, the image can be effectively corrected to conform to curved information of the windshield and then projected onto the windshield.

In an embodiment of the present disclosure, the stereoscopic image filter may be configured to include a parallax barrier. In another embodiment, the stereoscopic image filter may be configured to include a polarization controller and a first liquid-crystal lenticular lens sheet. In another embodiment, the stereoscopic image filter may be configured to include a first transparent electrode, a second liquid-crystal lenticular lens sheet, a lens body, and a second transparent electrode. Accordingly, the first image can be displayed in 3D while the second image is displayed in 2D, and 3D/2D conversion (mode conversion) of the first image can be easily performed.

In addition, according to the head-up display apparatus according to the embodiment of the present disclosure configured as described above, it is possible to easily adjust the degree of stereoscopicity (depth level) while enabling a 3D expression in a glasses-free manner.

### BRIEF DESCRIPTION OF DRAWINGS

FIG. 1 is a diagram schematically illustrating a state of using a head-up display apparatus according to an embodiment of the present disclosure.

FIG. 2 is a diagram schematically illustrating a state in which an image is projected onto a windshield of a vehicle by a head-up display apparatus according to another embodiment of the present disclosure, which is viewed from the interior of the vehicle.

FIG. 3A is a diagram schematically illustrating a state in which an image of a first region and an image of a second region are projected onto a windshield in a head-up display apparatus according to another embodiment of the present disclosure.

FIG. 3B is a diagram illustrating a state in which a first image and a second image are projected onto a windshield at different distances in a head-up display apparatus according to another embodiment of the present disclosure.

FIGS. 4A, 4B, and 4C are diagrams schematically illustrating a head-up display apparatus in which a stereoscopic image filter includes a parallax barrier, respectively, according to an embodiment of the present disclosure.

FIGS. 5A and 5B are diagrams illustrating a state in which a distance between a display panel and a stereoscopic image filter is varied in a head-up display apparatus according to another embodiment of the present disclosure.

FIG. 6 is a diagram schematically illustrating a state in which a stereoscopic image is formed by a left eye image and a right eye image in a head-up display apparatus according to another embodiment of the present disclosure.

FIGS. 7A and 7B are diagrams illustrating a display panel and a stereoscopic image filter in a head-up display apparatus according to another embodiment of the present disclosure.

FIGS. 8A and 8B are diagrams illustrating conversion between a 2D image and a 3D image in a head-up display apparatus according to another embodiment of the present disclosure.

FIG. 8C is a diagram illustrating a stereoscopic image filter in a head-up display apparatus according to another embodiment of the present disclosure.

FIGS. 9A and 9B are diagrams illustrating a state in which the degree of stereoscopicity (depth level) is adjusted in a head-up display apparatus according to another embodiment of the present disclosure.

FIGS. 10A, 10B, and 10C are diagrams schematically illustrating a state in which an image is projected onto a windshield by a head-up display apparatus according to another embodiment of the present disclosure, which viewed from the interior of a vehicle.

FIG. 11 is a diagram illustrating a state in which an image is displayed on a display panel in a head-up display apparatus according to another embodiment of the present disclosure.

FIG. 12 is a diagram illustrating a state in which a left eye image and a right eye image are warped and displayed on a display panel in a head-up display apparatus according to another embodiment of the present disclosure.

### BEST MODE FOR CARRYING OUT THE INVENTION

Hereinafter, in order to describe the present disclosure in more detail, embodiments according to the present disclosure will be described in more detail with reference to the accompanying drawings. Like reference numerals refer to like elements throughout the detailed description.

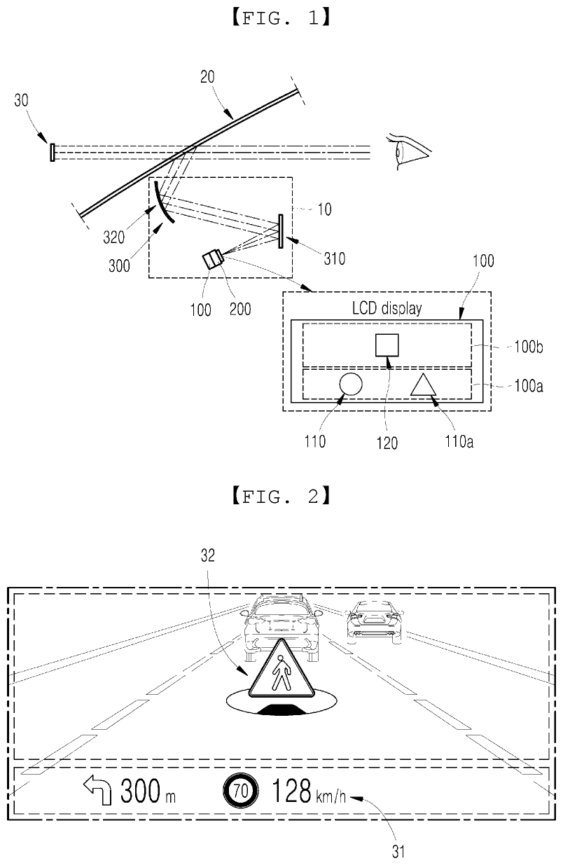

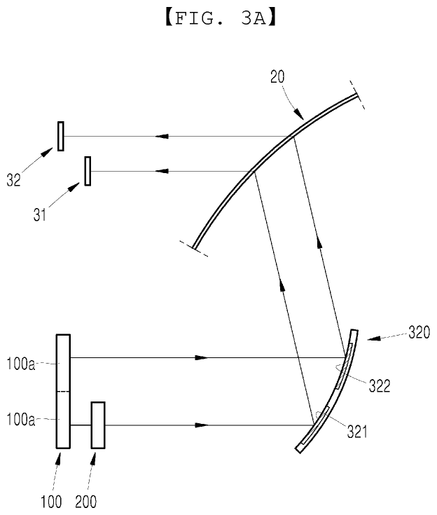

FIG. 1 is a diagram schematically illustrating a state of using a head-up display apparatus 10 according to an embodiment of the present disclosure. FIG. 2 is a diagram schematically illustrating a state in which an image is projected onto a windshield 20 by a head-up display apparatus 10 according to another embodiment of the present disclosure.

The head-up display apparatus 10 according to the embodiment of the present disclosure may be configured to project an image onto a curved windshield 20.

The head-up display apparatus 10 according to the embodiment of the present disclosure may be configured to include a display panel 100, a stereoscopic image filter 200, and an optical system 400.

The optical system 400 may be configured to reflect and/or refract light, and may include one or more mirrors 300, 310, and 320.

The display panel 100 is a device configured to display an image and may be formed in various ways. The display panel 100 may be configured to include an LCD (liquid crystal display) and a backlight (light source) provided on the rear surface of the LCD. The display panel 100 may be configured to include OLEDs (organic light emitting diodes).

The display panel 100 may be configured to include a first region 100a in which a first image 110 is displayed and a second region 100b in which a second image 120 is displayed.

The first region 100a and the second region 100b may display different information from each other.

The first region 100a may display driving information of a vehicle (a first vehicle) in which the head-up display apparatus 10 is installed, state information of the first vehicle, the current speed of the first vehicle, navigation information, and the like.

Two or more different images may be displayed in the first region 100a, and the first image 110 and an image 110a other than the first image 110 may be displayed therein.

The second region 100b may display information on the surroundings of the first vehicle, information on the relationship between the first vehicle and the surroundings of the first vehicle, and the like. For example, the second region 100b may display information on the distance between a vehicle (a second vehicle) located in front of the first vehicle and the first vehicle, information on the volume of traffic, information on the occurrence of an accident on the road ahead of the first vehicle, and the like.

An image (light) generated in the display panel 100 may be displayed as a 3D (three-dimensional) image by passing through the stereoscopic image filter 200.

The stereoscopic image filter 200 may be disposed in front of the display panel 100 (on the side in which light is emitted from the display panel 100) such that the image displayed on the display panel 100 may be converted into a stereoscopic image.

The stereoscopic image filter 200 may be disposed in front of the first region 100a of the display panel 100 to convert the first image 110 into a stereoscopic image.

The stereoscopic image filter 200 may be configured as a parallax barrier, a lenticular lens, a liquid-crystal lenticular lens sheet, a micro lens array, or the like.

The display panel 100 and the stereoscopic image filter 200 may be assembled with each other to configure a display module.

The mirrors 300 constituting the optical system 400 may be configured to include a reflecting mirror 310 and a concave mirror 320.

The reflecting mirror 310 and the concave mirror 320 reflect the light emitted from the display panel 100 and the light having passed through the stereoscopic image filter 200 toward the windshield 20, and thus the image of the second region 100b and the image having passed through the stereoscopic image filter 200 are projected onto the windshield 20.

Accordingly, the image 30 may be formed on the front of the windshield 20 of the vehicle so that the driver may see the image 30.

All of the images 110 and 110a of the first region 100a and the image 120 of the second region 100b may be projected onto the windshield 20, and the vehicle driver may observe an image (first image) 31 according to the image of the first region 100a and an image (second image) 32 according to the image of the second region 100b through the windshield 20.

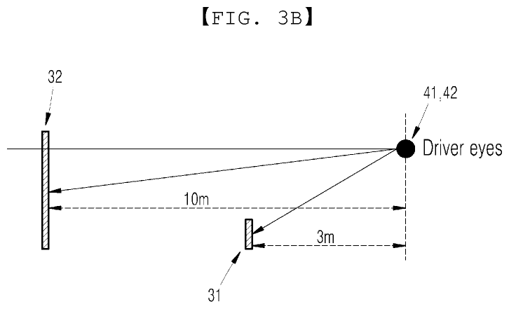

FIG. 3A is a diagram schematically illustrating a state in which an image of a first region 100a and an image of a second region 100b are projected onto a windshield 20 in a head-up display apparatus 10 according to another embodiment of the present disclosure, and FIG. 3B is a diagram illustrating a state in which a first image 110 and a second image 120 are projected onto a windshield 20 at different distances from a driver in a head-up display apparatus 10 according to another embodiment of the present disclosure.

In the head-up display apparatus 10 according to the embodiment of the present disclosure, the concave mirror 320 may be configured to include a first reflection region 321 and a second reflection region 322.

The first reflection region 321 is a region where an image according to the first region 100a of the display panel 100 is reflected.

The second reflection region 322 is a region where an image according to the second region 100b of the display panel 100 is reflected, which is separated from the first reflection region 321.

According to the embodiment of the present disclosure, a radius of curvature of the first reflection region 321 and a radius of curvature of the second reflection region 322 may be configured to be different from each other. The radius of curvature of the first reflection region 321 may be configured to be smaller than the radius of curvature of the second reflection region 322, or the radius of curvature of the first reflection region 321 may be configured to be greater than the radius of curvature of the second reflection region 322.

In the head-up display apparatus 10 according to the embodiment of the present disclosure configured as described above, the focal length of the first image 31 and the focal length of the second image 32 may be configured to be different from each other, and the distance from the driver to the first image 31 and the distance from the driver to the second image 32 may be configured to be different from each other.

For example, the distance (e.g., 3 m) from the driver to the first image 31 may be relatively short, and the distance from the driver to the second image 32 (e.g., 10 m) may be relatively long.

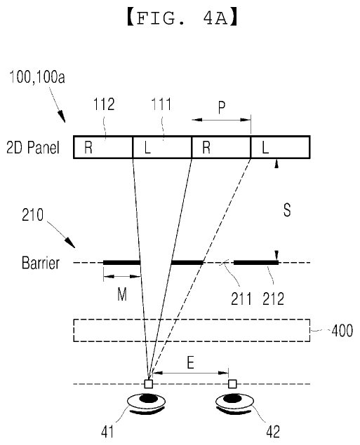

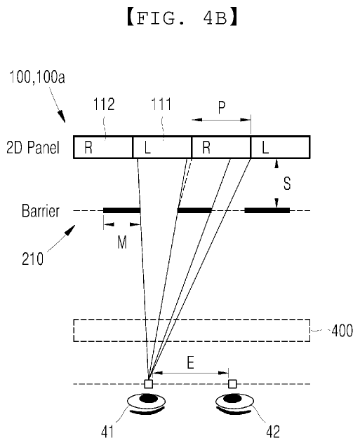

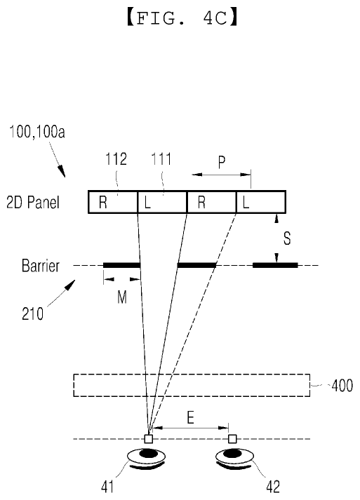

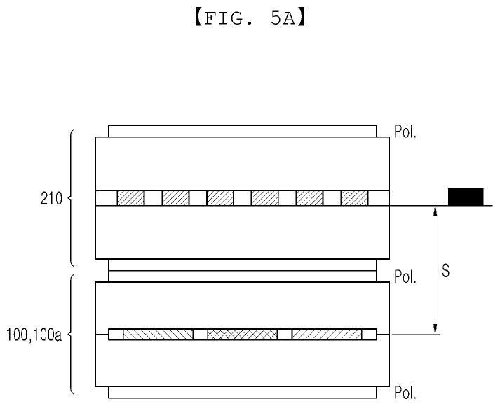

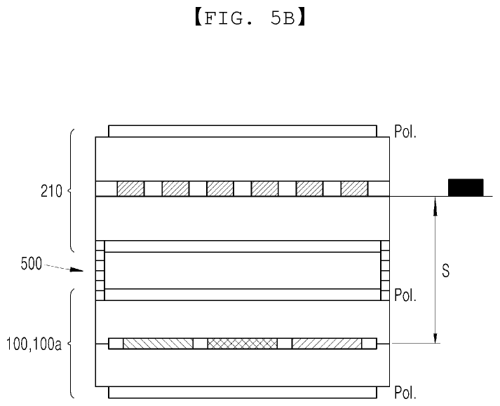

FIGS. 4A, 4B, and 4C are diagrams schematically illustrating a head-up display apparatus 10 in which a stereoscopic image filter 200 includes a parallax barrier 210, respectively, according to the embodiment of the present disclosure, FIGS. 5A and 5B are diagrams illustrating a state in which a distance between a display panel 100 and a stereoscopic image filter 200 is varied in a head-up display apparatus 10 according to another embodiment of the present disclosure, and FIG. 6 is a diagram schematically illustrating a state in which a stereoscopic image is formed by a left eye image 111 and a right eye image 112 in a head-up display apparatus 10 according to another embodiment of the present disclosure.

Although an image (light) radiated from the display panel 100 is reflected and/or refracted while passing through the optical system 400 so that a stereoscopic image (3D) is recognized by the left eye 41 and the right eye 42 of the driver, FIGS. 4A to 4C and FIG. 6 illustrate that the image radiated from the display panel 100 proceeds in a straight line to the left eye 41 and the right eye 42 of the driver for convenience of explanation.

In the head-up display apparatus 10 according to the embodiment of the present disclosure, the stereoscopic image filter 200 may be configured to include a parallax barrier 210.

The parallax barrier 210 may be configured as a transparent liquid crystal and may include a plurality of channels. The plurality of channels of the parallax barrier 210 may individually become transparent or opaque according to a control signal of a control unit provided in the head-up display apparatus 10. The parallax barrier 210 has a section 211 (slit section) in which the channel is transparent and a section 212 (block section) in which the channel is opaque, which are repeatedly provided. The slit section 211 may transmit light of the image displayed on the display panel 100, and the block section 212 is an opaque section through which light is unable to pass.

In the head-up display apparatus 10 according to the embodiment of the present disclosure, the degree of stereoscopicity (depth level) of the image projected and formed onto the windshield 20 may be adjusted, and the distance between the display panel 100 and the stereoscopic image filter 200 may be variable.

A stepping motor 500 capable of adjusting the rear distance S may be provided between the display panel 100 and the stereoscopic image filter 200.

In the head-up display apparatus 10 according to the embodiment of the present disclosure, a disparity image, in which a left eye image 111 and a right eye image 112 are combined, may be displayed on the display panel 100 or the first region 100a of the display panel 100.

The first image 110 displayed in the first region 100a of the display panel 100 may be a disparity image in which the left eye image 111 and the right eye image 112 are combined, and the width and spacing of each of the left eye image 111 and the right eye image 112 may be variable.

When the rear distance S is changed as the parallax barrier 210 moves relative to the display panel 100, thereby causing a barrier offset (see FIG. 4B), the three-dimensional effect of the 3D image of the parallax barrier 210 may be degraded by crosstalk.

In order to prevent the degradation of the three-dimensional effect, the width M of the slit section 211 and the block section 212 may be adjusted, and the width P of the left eye image 111 and the right eye image 112 may be adjusted (see FIG. 4C).

The depth level may indicate the degree of a three-dimensional effect appearing in the 3D image of the parallax barrier 210. As the depth level increases, the driver may feel that the three-dimensional effect of the 3D image of the parallax barrier 210 is superior. According to an embodiment, as the depth level increases, the driver may feel that objects displayed in the 3D image of the parallax barrier 210 are closer. When the depth level of the 3D image of the parallax barrier 210 is 0, a 2D image without a three-dimensional effect may be displayed.

In the head-up display apparatus 10 according to the embodiment of the present disclosure, a depth level may be adjusted by adjusting the disparity image.

In the disparity image, the greater the distance between the position of an object visible to the driver's left eye 41 and the position of an object visible to the driver's right eye 42, the higher the depth level of the 3D image of the parallax barrier 210. In this case, the driver viewing the 3D image of the parallax barrier 210 may feel a relatively superior three-dimensional effect.

On the other hand, the smaller the distance between the position of an object visible to the driver's left eye 41 and the position of an object visible to the driver's right eye 42, the lower the depth level. In the disparity image, when the position of an object visible to the driver's left eye 41 and the position of an object visible to the driver's right eye 42 are the same, the depth level becomes 0.

The left eye image 111 and the right eye image 112 may be displayed on the display panel 100 or the first region 100a of the display panel 100, and the left eye image 111 and the right eye image 112 may be displayed on the display panel 100 while overlapping each other, and in this case, the driver may recognize the object 31 according to the left eye image 111 and the right eye image 112.

The first left eye image 111a and the first right eye image 112a may be displayed on the display panel 100 or the first region 100a of the display panel 100, and the driver may recognize that as if an image were formed at a point where the extension line connecting the left eye 41 of the driver with the first left eye image 111a and the extension line connecting the right eye 42 of the driver with the first right eye image 112a intersect each other, thereby recognizing a first object 31a.

In addition, a second left eye image 111b and a second right eye image 112b may be displayed on the display panel 100 or the first region 100a of the display panel 100, and the driver may recognize that as if an image were formed at a point where the extension line connecting the left eye 41 of the driver with the second left eye image 111b and the extension line connecting the right eye 42 of the driver with the second right eye image 112b intersect each other, thereby recognizing a second object 31b.

In addition, a third left eye image 111c and a third right eye image 112c may be displayed on the display panel 100 or the first region 100a of the display panel 100, and the driver may recognize that as if an image were formed at a point where the extension line connecting the left eye 41 of the third left eye image 111c with the extension line connecting the right eye 42 of the driver with the third right eye image 112c intersect each other, thereby recognizing a third object 31c.

As described above, the object may be recognized as being located behind the reference point (depth is (−)) or as being located in front of the reference point (depth is (+)) by adjusting the distance between the left eye image 111 and the right eye image 112.

When the object is recognized as being located in front of the reference point (depth is (+)), the driver may recognize that the image further protrude in the direction toward the driver.

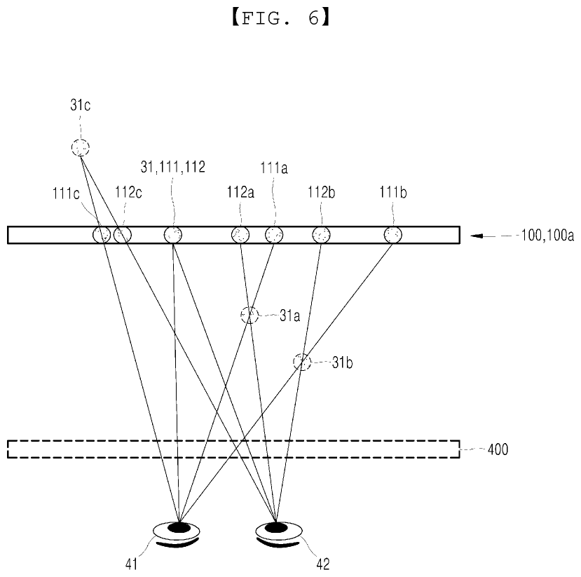

FIGS. 7A and 7B are diagrams illustrating a display panel 100 and a stereoscopic image filter 200 in a head-up display apparatus 10 according to another embodiment of the present disclosure.

The stereoscopic image filter 200 may be configured to include a polarization controller 220 and a first liquid-crystal lenticular lens sheet 230.

In the head-up display apparatus 10 according to the embodiment of the present disclosure, the polarization controller 220 may be configured to change the polarization directions of light beams configuring the image of the display panel 100, and may be configured to change the polarization directions of light beams configuring the first image 110.

In the head-up display apparatus 10 according to the embodiment of the present disclosure, the first liquid-crystal lenticular lens sheet 230 is configured to refract or not refract the light beam that has passed through the polarization controller 220 according to the polarization direction.

In the head-up display apparatus 10 according to the embodiment of the present disclosure, the polarization controller 220 and the first liquid-crystal lenticular lens sheet 230 may be provided in front of the first region 100a of the display panel 100 (see FIG. 7A), or may be provided over the entire area of the display panel 100 (the area including the first region 100a and the second region 100b) (see FIG. 7B).

In the head-up display apparatus 10 according to the embodiment of the present disclosure, a glass panel 225 made of glass may be provided between the display panel 100 and the polarization controller 220. In addition, a polarization film may be provided in front of the display panel 100.

The polarization controller 220 may be provided in front of the display panel 100, and may change the polarization direction of a light beam emitted from the display panel 100 by on/off control of the polarization controller 220 (turning on/off a switch 224).

The polarization controller 220 includes a lower layer 221 and an upper layer 222, which are spaced apart from each other, and a liquid crystal element layer 223 provided between the lower layer 221 and the upper layer 222.

The lower layer 221 and the upper layer 222 may include an outer layer of a non-conductive material and an inner layer of a conductive material, respectively, and inner layers of the lower layer 221 and the upper layer 222 may be connected by a switch 224.

The first liquid-crystal lenticular lens sheet 230 is provided in front of the polarization controller 220 to refract or not refract a light beam that has passed through the polarization controller 220 according to the polarization direction. The first liquid-crystal lenticular lens sheet 230 includes an engraved lens sheet 232 having a plurality of concave portions formed therein and a plurality of convex lenses 231 filled in the concave portions of the engraved lens sheet 232 to refract or not refract the light beam according to the polarization direction.

The liquid-crystal arrangement (optical property) may be changed by turning on or off the switch 224 of the polarization controller 220 in the liquid crystal element layer 223, so that the polarization direction of the light beam is changed, and when passing through the convex lens 231 of the first liquid-crystal lenticular lens sheet 230, the convex lens 231 may have the same refractive index as or a different refractive index from the engraved lens sheet 232 due to refractive index anisotropy (birefringence effect), thereby realizing a 2D image mode or a 3D image mode.

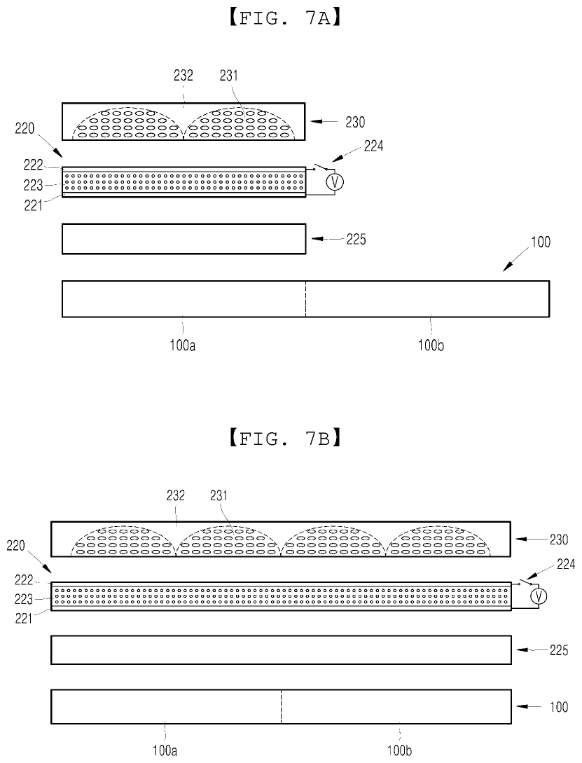

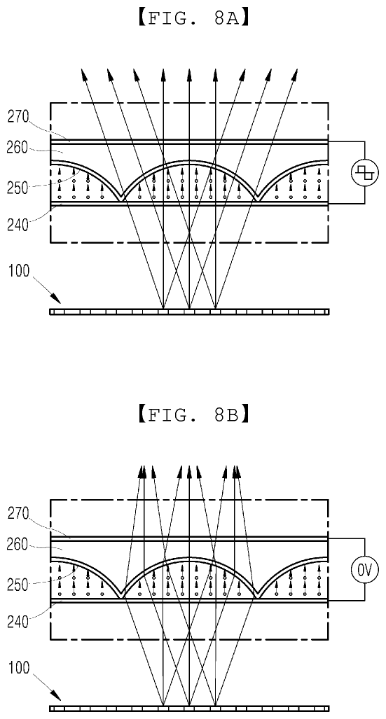

FIGS. 8A and 8B are diagrams illustrating conversion between a 2D image and a 3D image in a head-up display apparatus 10 according to another embodiment of the present disclosure.

FIG. 8C is a diagram illustrating a stereoscopic image filter 200 in a head-up display apparatus 10 according to another embodiment of the present disclosure.

In the embodiment of the present disclosure, the stereoscopic image filter 200 may be configured to include a first transparent electrode 240, a second liquid-crystal lenticular lens sheet 250 disposed in front of the first transparent electrode 240, a lens body 260 disposed in front of the second liquid-crystal lenticular lens sheet 250, and a second transparent electrode 270 disposed in front of the lens body 260.

The second liquid-crystal lenticular lens sheet 250 may be a lenticular lens layer including semi-cylindrical lenses including liquid crystal. The semi-cylindrical lens may be formed of a polymer material, and the lens body 260 may be a replica.

A voltage may or may not be applied to the second liquid-crystal lenticular lens sheet 250 through the first transparent electrode 240 and the second transparent electrode 270, and the alignment direction of the liquid crystal in the second liquid-crystal lenticular lens sheet 250 may be changed according thereto, and the refractive indices of the second liquid-crystal lenticular lens sheet 250 and the lens body 260 may be controlled to be the same as or different from each other.

As shown in FIG. 8A, in the stereoscopic image filter 200, a voltage may be applied to the second liquid-crystal lenticular lens sheet 250 through the first transparent electrode 240 and the second transparent electrode 270 so as to align the liquid crystal such that the refractive indices of each lens of the second liquid-crystal lenticular lens sheet 250 and the lens body 260 are the same, so that the image formed on the display panel 100 may be output as it is through the second liquid-crystal lenticular lens sheet 250 and the lens body 260, and the left eye image 111 and the right eye image 112 may be sequentially output through the second liquid-crystal lenticular lens sheet 250 and the lens body 260. Accordingly, a 2D image may be displayed.

As shown in FIG. 8B, in the stereoscopic image filter 200, a voltage may not be applied to the second liquid-crystal lenticular lens sheet 250 through the first transparent electrode 240 and the second transparent electrode 270 so as to align the liquid crystal such that the refractive indices of each lens of the second liquid-crystal lenticular lens sheet 250 and the lens body 260 are different from each other. Accordingly, the image formed by the display panel 100 may be output through the second liquid-crystal lenticular lens sheet 250 and the lens body 260 in the state in which the refractive index is different between the second liquid-crystal lenticular lens sheet 250 and the lens body 260, thereby outputting a glasses-free 3D image.

In the head-up display apparatus 10 according to the embodiment of the present disclosure, the first transparent electrode 240 may be configured to include a 1-1st transparent electrode 241 and a 1-2nd transparent electrode 242, which are separated from each other, and the second transparent electrode 270 may be configured to include a 2-1st transparent electrode 271 and a 2-2nd transparent electrode 272, which are separated from each other.

The operation of the 1-1st transparent electrode 241 and the 2-1st transparent electrode 271 configuring a pair may be performed separately from the operation of the 1-2nd transparent electrode 242 and the 2-2nd transparent electrode 272 configuring a pair.

Accordingly, a 3D image may be output in the region where the 1-1st transparent electrode 241 and the 2-1st transparent electrode 271 are formed by making a difference in the refractive index between the second liquid-crystal lenticular lens sheet 250 and the lens body 260, and a 2D image may be output in the region where the 1-2nd transparent electrode 242 and the 2-2nd transparent electrode 272 are formed by making no difference in the refractive index between the second liquid-crystal lenticular lens sheet 250 and the lens body 260.

For example, the first image 110 in the first region 100a may be refracted through the region where the 1-1st transparent electrode 241 and the 2-1st transparent electrode 271 are formed, and an image 110a other than the first image 110 in the first region 100a may not be refracted through the region where the 1-2nd transparent electrode 242 and the 2-2nd transparent electrode 272 are formed, thereby outputting the first image 110 in 3D and outputting the image other than the first image 110 in the first region 100a in 2D.

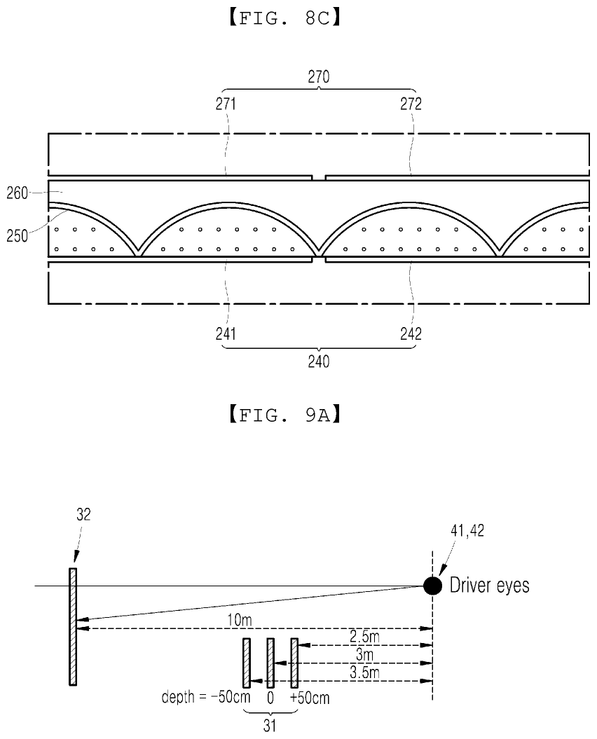

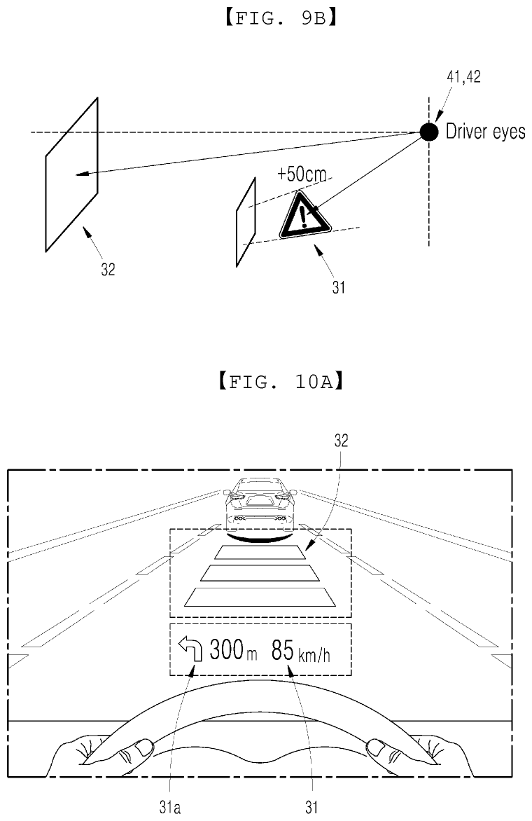

FIGS. 9A and 9B are diagrams illustrating a state in which the degree of stereoscopicity (depth level) is adjusted in a head-up display apparatus 10 according to another embodiment of the present disclosure.

As described above, in the head-up display apparatus 10 according to the embodiment of the present disclosure, light according to the second image 120 of the second region 100b may be projected onto the windshield 20 to display the second image 32 in 2D, and light according to the first image 110 of the first region 100a may be projected onto the windshield 20 to display the first image 31 in 3D, and the first image 31 may be adjusted is the degree of stereoscopicity (depth level) thereof.

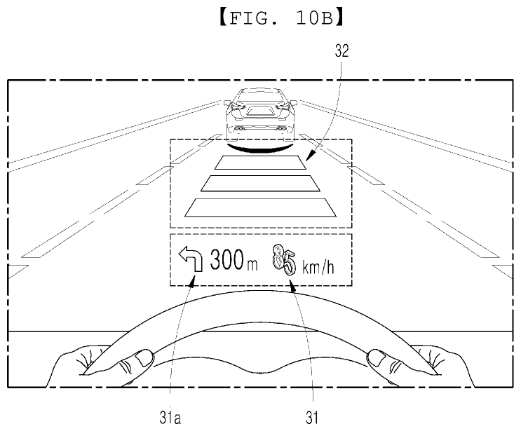

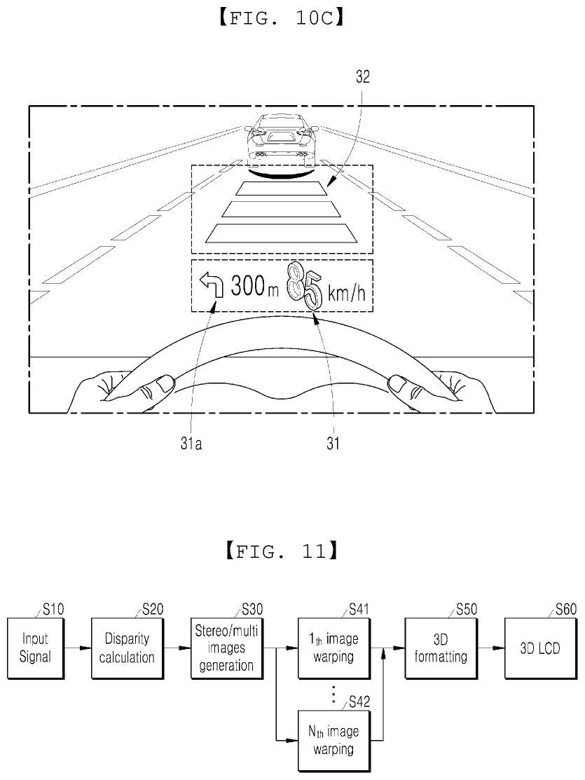

FIGS. 10A, 10B, and 10C are diagrams schematically illustrating a state in which an image is projected onto a windshield 20 by a head-up display apparatus 10 according to another embodiment of the present disclosure.

As described above, in the head-up display apparatus 10 according to the embodiment of the present disclosure, the first image 110 and the image 110a other than the first image 110 may be displayed in the first region 100a, and in this case, the first image 31 according to the first image 110 may be displayed in 2D or 3D.

In addition, when the first image 31 is displayed in 3D, the distance between the left eye image 111 and the right eye image 112 constituting the first image 110 may be adjusted so that the driver may recognize that the object is located in front of the reference point and that the first image 31 protrudes in the direction to the driver.

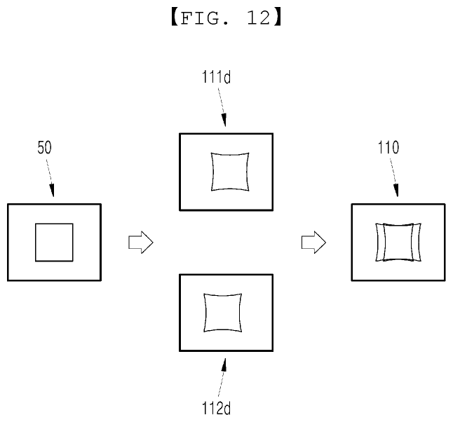

FIG. 11 is a diagram illustrating a state in which an image is displayed on a display panel 100 in a head-up display apparatus 10 according to another embodiment of the present disclosure.

FIG. 12 is a diagram illustrating a state in which a left eye image 111 and a right eye image 112 are warped and displayed on a display panel 100 in a head-up display apparatus 10 according to another embodiment of the present disclosure.

When an image is displayed on the display panel 100 in order to output the first image 110 in 3D, a signal for the image 50 to be displayed may be input. (S10)

A disparity between the image recognized by the left eye 41 and the image recognized by the right eye 42 may be determined according to the degree of stereoscopicity (depth level) required to output the image 50 as a 3D image. (S20) The left eye image 111 and the right eye image 112 are determined according to the disparity. (S30)

In the display panel 100 according to the embodiment of the present disclosure, the image is warped and displayed on the display panel 100 so that distortion of the image projected onto the windshield 20 is reduced. (S41 and S42) That is, when an image is projected onto the windshield 20 with a curved surface, an image capable of compensating for distortion is displayed on the display panel 100 so as to prevent distortion of the first image 31 output through the curved surface of the windshield 20.

For example, in the case of outputting the image 50 in 3D, if the first image output in a non-warped state is formed in a convex shape, compared to the original image 50, due to the curved surface of the windshield 20, the first image 110 may be transformed (warped) in a concave shape in advance and then displayed on the display panel 100.

As another example, in the case of outputting the image 50 in 3D, if the first image output in a non-warped state is formed in a concave shape, compared to the original image 50, due to the curved surface of the windshield 20, first image 110 may be transformed (warped) in a convex shape in advance and then displayed on the display panel 100.

In addition, the warping of the left eye image 111d (S41) and the warping of the right eye image 112d (S42) are respectively performed, and the warped left eye image 111d and the warped right eye image 112d are combined to configure a disparity image (S50), and then the disparity image is displayed on the display panel 100. (S60)

In the head-up display apparatus 10 according to the embodiment of the present disclosure, the degree of warping of the first image 110 may be controlled depending on the curvature of the projected point on the windshield 20 (curvature of the windshield at a corresponding point). In the case where the curvature of the point at which light is projected onto the windshield 20 is large, the degree of warping may increase, and in the case where the curvature of the point at which light is projected onto the windshield 20 is small, the degree of warping may decrease.

As described above, according to the head-up display apparatus 10 according to the embodiment of the present disclosure, it is possible to display safety-related information in 3D through the first region 100a of the display panel 100 during driving, thereby enabling enhancement of visibility, fast delivery of information, and, accurate 3D expression.

In addition, when the image projected onto the windshield 20 is displayed in 3D, the image may be effectively corrected to conform to the curved surface information of the windshield 20 and then projected onto the windshield 20.

Although specific embodiments of the present disclosure have been described and illustrated above, the present disclosure is not limited to the described embodiments, and those of ordinary skill in the art may understand that various changes and modifications to other specific embodiments can be made without departing from the spirit and scope of the present disclosure.

Accordingly, the scope of the present disclosure should be defined by the technical idea described in the claims, instead of being defined by the described embodiments.

### INDUSTRIAL APPLICABILITY

In the head-up display apparatus according to the embodiment of the present disclosure, at least a portion of the image displayed on a display panel is warped and displayed, thereby preventing distortion of a stereoscopic image projected onto a windshield, so industrial applicability of the present disclosure is remarkable in consideration thereof.

1. A head-up display apparatus to project an image onto a curved windshield of a vehicle, the apparatus comprising:
a display panel comprising a first region in which a first image is displayed and a second region in which a second image is displayed;
a stereoscopic image filter disposed in front of the first region and configured to convert the first image into a stereoscopic image; and
one or more mirrors configured to project an image of the second region and an image that has passed through the stereoscopic image filter onto the windshield,
wherein the first image is warped and displayed on the display panel so that distortion of the image projected onto the windshield is reduced, the first image is displayed in 3D through the first region during driving of the vehicle, and 3D/2D conversion of the first image is performed.

2. The head-up display apparatus according to claim 1, wherein the mirror comprises a concave mirror, and
wherein the concave mirror comprises:
a first reflection region from which an image according to the first region is reflected; and
a second reflection region, separated from the first reflection region, from which an image according to the second region is reflected.

3. The head-up display apparatus according to claim 2, wherein a radius of curvature of the first reflection region and a radius of curvature of the second reflection region are different from each other.

4. The head-up display apparatus according to claim 1, wherein the stereoscopic image filter is configured to include a parallax barrier, and
wherein the distance between the display panel and the stereoscopic image filter is variable so that depth level of the image projected onto the windshield is adjusted.

5. The head-up display apparatus according to claim 1,
wherein the stereoscopic image filter is configured to include a parallax barrier, wherein the first image is a disparity image in which a left eye image and a right eye image are combined, and
wherein the distance between the left eye image and the right eye image is variable so that depth level of the image projected onto the windshield is adjusted.

6. The head-up display apparatus according to claim 1, wherein the first image is a disparity image in which a left eye image and a right eye image are combined, and
wherein the left eye image and the right eye image are respectively warped and displayed on the display panel to form the disparity image.

7. The head-up display apparatus according to claim 1, wherein the stereoscopic image filter comprises:
a polarization controller configured to change the polarization direction of a light beam constituting the first image; and
a first liquid-crystal lenticular lens sheet configured to refract or not refract a light beam that has passed through the polarization controller according to the polarization direction.

8. The head-up display apparatus according to claim 1, wherein the stereoscopic image filter comprises:
a first transparent electrode;
a second liquid-crystal lenticular lens sheet disposed in front of the first transparent electrode;
a lens body disposed in front of the second liquid-crystal lenticular lens sheet; and
a second transparent electrode disposed in front of the lens body,
wherein the refractive indices of the second liquid-crystal lenticular lens sheet and the lens body are controlled to be the same as or different from each other depending on a voltage that is or is not applied to the second liquid-crystal lenticular lens sheet through the first transparent electrode and the second transparent electrode.

9. The head-up display apparatus according to claim 8, wherein the first transparent electrode comprises a 1-1st transparent electrode and a 1-2nd transparent electrode, which are separated from each other,
wherein the second transparent electrode comprises a 2-1st transparent electrode and a 2-2nd transparent electrode, which are separated from each other, and
wherein the operation of the 1-1st transparent electrode and the 2-1st transparent electrode configuring a pair is performed separately from the operation of the 1-2nd transparent electrode and the 2-2nd transparent electrode configuring da pair.

10. The head-up display apparatus according to claim 1, wherein the degree of warping of the first image is controlled depending on the curvature of a projected point on the windshield.

11. A head-up display apparatus to project an image onto a curved windshield of a vehicle, the apparatus comprising:
a display panel configured to produce and display an image;
a stereoscopic image filter disposed in front of the display panel and configured to convert an image of the display panel into a stereoscopic image; and
one or more mirrors configured to project an image that has passed through the stereoscopic image filter onto the windshield,
wherein the image is warped and displayed on the display panel so that distortion of the image projected onto the windshield is reduced, the image is displayed in 3D through the display panel during driving of the vehicle, and 3D/2D conversion of the image is performed.

12. The head-up display apparatus according to claim 11, wherein the stereoscopic image filter is configured to include a parallax barrier, and
wherein the distance between the display panel and the stereoscopic image filter is variable so that depth level of the image projected onto the windshield is adjusted.

13. The head-up display apparatus according to claim 11, wherein the stereoscopic image filter is configured to include a parallax barrier,
wherein a disparity image in which a left eye image and a right eye image are combined is displayed on the display panel, and
wherein the distance between the left eye image and the right eye image is variable so that depth level of the image projected onto the windshield is adjusted.

14. The head-up display apparatus according to claim 11, wherein a disparity image in which a left eye image and a right eye image are combined is displayed on the display panel, and
wherein the left eye image and the right eye image are respectively warped and displayed on the display panel to form the disparity image.

15. The head-up display apparatus according to claim 11, wherein the stereoscopic image filter comprises:
a polarization controller configured to change the polarization direction of a light beam constituting the image displayed on the display panel; and
a first liquid-crystal lenticular lens sheet configured to refract or not refract a light beam that has passed through the polarization controller according to the polarization direction.

16. The head-up display apparatus according to claim 11, wherein the stereoscopic image filter comprises:
a first transparent electrode;
a second liquid-crystal lenticular lens sheet disposed in front of the first transparent electrode;
a lens body disposed in front of the second liquid-crystal lenticular lens sheet; and
a second transparent electrode disposed in front of the lens body,
wherein the refractive indices of the second liquid-crystal lenticular lens sheet and the lens body are controlled to be the same as or different from each other depending on a voltage that is or is not applied to the second liquid-crystal lenticular lens sheet through the first transparent electrode and the second transparent electrode.

17. The head-up display apparatus according to claim 16, wherein the first transparent electrode comprises a 1-1st transparent electrode and a 1-2nd transparent electrode, which are separated from each other,
wherein the second transparent electrode comprises a 2-1st transparent electrode and a 2-2nd transparent electrode, which are separated from each other, and
wherein the operation of the 1-1st transparent electrode and the 2-1st transparent electrode configuring a pair is performed separately from the operation of the 1-2nd transparent electrode and the 2-2nd transparent electrode configuring a pair.

18. A head-up display apparatus to project an image onto a curved windshield of a vehicle, the apparatus comprising:
a display panel configured to produce and display an image;
a stereoscopic image filter disposed in front of the display panel and configured to convert at least a partial image of the display panel into a stereoscopic image; and
an optical system configured to cause light passing through the stereoscopic image filter to form an image,
wherein the image is warped and displayed on the display panel, the image is displayed in 3D through the display panel during driving of the vehicle, and 3D/2D conversion of the image is performed.
